(19) United States
(12) Patent Application Publication
(10) Pub. No.: US 2021/0402668 A1
(43) Pub. Date: Dec. 30, 2021

(54) MULTI-MATERIAL PRINTING DEVICE FOR ENERGY STORAGE AND CONVERSION APPLICATIONS

(71) Applicants: VANDERBILT UNIVERSITY, Nashville, TN (US); GEORGIA TECH RESEARCH CORPORATION, Atlanta, GA (US)

(72) Inventors: Kelsey B. HATZELL, Nashville, TN (US); Marta C. HATZELL, Atlanta, GA (US); Marm B. Dixit, Nashville, TN (US)

(21) Appl. No.: 17/279,260

(22) PCT Filed: Sep. 27, 2019
(86) PCT No.: PCT/US2019/053526

§ 371 Date: Mar. 24, 2021

Related U.S. Application Data
(60) Provisional application No. 62/737,467, filed on Sep. 27, 2018.

(51) Int. Cl. B29C 48/70; B29C 48/08; B29C 48/18

(52) U.S. Cl. CPC B29C 48/705; B29L 2031/3468; B29C 48/18; B29C 48/08

(57) ABSTRACT

Various implementations include a coextrusion device including a first shim plate and a second shim plate coupled to the first shim plate. The first and second shim plates each have a first side, a second side opposite and spaced apart from the first side, a first end, and a second end opposite and spaced apart from the first end. The second end defines one or more outlet openings. A flow channel extends from each of the one or more outlet openings and extends along a centralized axis from the second end toward the first end. A central plane extends perpendicular to the first side and along each of the centralized axes of each shim plate. The central planes of the first and second shim plates intersect an axis perpendicular to the central planes and are spaced apart from each other.

### CROSS REFERENCE TO RELATED APPLICATION

This application claims the benefit of U.S. Provisional Patent Application No. 62/737,467, entitled “Multi-Material Printing Device for Energy Storage and Conversion Applications,” filed Sep. 27, 2018, the content of which is herein incorporated by reference in its entirety.

### STATEMENT REGARDING FEDERALLY SPONSORED RESEARCH

This invention was made with government support under Grant no. 1727863 awarded by the National Science Foundation and Grant no. 1727668 awarded by the National Science Foundation. The government has certain rights in the invention.

### BACKGROUND

Coextrusion manufacturing is the process of joining two or more materials into a layered structure by extruding feedstock material through a die. Coextrusion can be used for manufacturing a wide array of morphologies including, fibers, concentric tubes, and laminar structures. These structures are typically characterized by improved or even “meta” material properties (strength, durability, and toughness) because of the alignment induced by flow during the coextrusion process. Currently, coextrusion is widely used to manufacture multi-layer polymer films for applications in medical, food, and energy industries.

In practice, various layers are formed, through introducing two or more polymer melts into a single injector or die block. The stratified polymers or extrudates merge and weld into a structure before melt solidification. Maintaining integrity and adhesion at the interface during shear-based processing remains the greatest challenge, as instabilities (interfacial, wave, zig-zag, scattering) and encapsulation can cause unwanted polymer mixing or delamination. Interfacial stability induced due to stratified flows is a phenomenon well studied within fluid dynamics. The onset of interfacial instability has been linked with the critical interfacial shear stress of the polymer material systems being extruded. Typically, by controlling processing parameters such as skin-layer viscosity, skin-to-core ratio, extrusion rate, and die gap, interfacial instabilities can be controlled. While there is a significant body of literature studying coextrusion of melt material systems, there has been far less work studying feedstock materials which are colloid based and which require a solvent evaporation process.

Thus, there is a need for a coextrusion system which has the capability to co-extrude colloidal fluids.

### BRIEF SUMMARY

Various implementations include a coextrusion device. The device includes a first shim plate and a second shim plate. The first shim plate has a first side, a second side opposite and spaced apart from the first side of the first shim plate, a first end, and a second end opposite and spaced apart from the first end of the first shim plate. The second end of the first shim plate defines one or more first outlet openings. A first flow channel extends from each of the one or more first outlet openings and extends along a centralized first axis from the second end of the first shim plate toward the first end of the first shim plate.

The second shim plate is coupled to the first shim plate. The second shim plate has a first side, a second side opposite and spaced apart from the first side of the second shim plate, a first end, and a second end opposite and spaced apart from the first end of the second shim plate. The second end of the second shim plate defines one or more second outlet openings. The second flow channel extends from each of the one or more second outlet openings and extends along a centralized second axis from the second end of the second shim plate toward the first end of the second shim plate.

A first central plane extends perpendicular to the first side of the first shim plate and along each of the centralized first axes, and a second central plane extends perpendicular to the first side of the second shim plate and along each of the centralized second axes. The first central planes and second central planes intersect an axis perpendicular to the first central planes and second central planes and are spaced apart from each other.

In some implementations, each of the first outlet openings has a first edge and a second edge. The first edge and the second edge are opposite and spaced apart from each other. An edge plane extends along each of the first edges and second edges, and none of the edge planes intersects any of the one or more second outlet openings.

In some implementations, the one or more first flow channels are not in fluid communication with the one or more second flow channels.

In some implementations, the device further includes a flow separator having a first side, a second side opposite and spaced apart from the first side of the flow separator, a first end, and a second end opposite and spaced apart from the first end of the flow separator. The second side of the first shim plate is coupled to the first side of the flow separator, and the second side of the flow separator is coupled to the first side of the second shim plate.

In some implementations, the device further includes a first flow divider and a second flow divider. The first flow divider has a first side, a second side opposite and spaced apart from the first side of the first flow divider, a first end, and a second end opposite and spaced apart from the first end of the first flow divider. The first side of the first flow divider defines a first divider opening extending from the first side of the first flow divider to the second side of the first flow divider.

The second flow divider has a first side, a second side opposite and spaced apart from the first side of the second flow divider, a first end, and a second end opposite and spaced apart from the first end of the second flow divider. The first side of the second flow divider defines a second divider opening extending from the first side of the second flow divider to the second side of the second flow divider.

The second side of the first flow divider is coupled to the first side of the first shim plate such that the first divider opening is in fluid communication with each of the one or more first flow channels. The second side of the second shim plate is coupled to the first side of the second flow divider such that the second divider opening is in fluid communication with each of the one or more second flow channels.

In some implementations, the device further includes a first inlet plate and a second inlet plate. The first inlet plate has a first side, a second side opposite and spaced apart from the first side of the first inlet plate, a first end, and a second end opposite and spaced apart from the first end of the first inlet plate. The first side of the first inlet plate defines a first inlet port extending from the first side of the first inlet plate to the second side of the first inlet plate.

The second inlet plate has a first side, a second side opposite and spaced apart from the first side of the second inlet plate, a first end, and a second end opposite and spaced apart from the first end of the second inlet plate. The first side of the second inlet plate defines a second inlet port extending from the first side of the second inlet plate to the second side of the second inlet plate.

The second side of the first inlet plate is coupled to the first side of the first flow divider such that the first inlet port is in fluid communication with each of the one or more first flow channels. The second side of the second flow divider is coupled to the first side of the second inlet plate such that the second inlet port is in fluid communication with each of the one or more second flow channels.

Each of the first inlet plate, the first flow divider, the first shim plate, the flow divider, the second shim plate, the second flow divider, and the second inlet plate include at least one fastener opening for coupling the first inlet plate, the first flow divider, the first shim plate, the flow divider, the second shim plate, the second flow divider, and the second inlet plate to each other.

In some implementations, the device further includes a first pressure regulator and a second pressure regulator. The first pressure regulator is in fluid communication with the one or more first flow channels and is configured to regulate the pressure of a first fluid to the first flow channels. The second pressure regulator is in fluid communication with the one or more second flow channels and is configured to regulate the pressure of a second fluid to the one or more second flow channels.

In some implementations, the device further includes a computer numerical control (CNC) machine coupled to the first and second shim plates.

In some implementations, the first fluid and the second fluid each comprise an ion conductor.

Various other implementations include a method of coextruding a solid electrolyte film. The method includes positioning a coextrusion device above a surface; introducing a first fluid into each of the first flow channels such that the first fluid flows through the first flow channels, out of the one or more first outlet openings, and onto the surface; introducing a second fluid into each of the second flow channels such that the second fluid flows through the second flow channels, out of the one or more second outlet openings, and onto the surface; and moving the device in a direction parallel to the surface.

The device includes a first shim plate and a second shim plate. The first shim plate has a first side, a second side opposite and spaced apart from the first side of the first shim plate, a first end, and a second end opposite and spaced apart from the first end of the first shim plate. The second end of the first shim plate defines one or more first outlet openings. A first flow channel extends from each of the one or more first outlet openings and extends along a centralized first axis from the second end of the first shim plate toward the first end of the first shim plate.

The second shim plate is coupled to the first shim plate. The second shim plate has a first side, a second side opposite and spaced apart from the first side of the second shim plate, a first end, and a second end opposite and spaced apart from the first end of the second shim plate. The second end of the second shim plate defines one or more second outlet openings. The second flow channel extends from each of the one or more second outlet openings and extends along a centralized second axis from the second end of the second shim plate toward the first end of the second shim plate.

A first central plane extends perpendicular to the first side of the first shim plate and along each of the centralized first axes, and a second central plane extends perpendicular to the first side of the second shim plate and along each of the centralized second axes. The first central planes and second central planes intersect an axis perpendicular to the first central planes and second central planes and are spaced apart from each other.

In some implementations, each of the first outlet openings has a first edge and a second edge. The first edge and the second edge are opposite and spaced apart from each other. An edge plane extends along each of the first edges and second edges, and none of the edge planes intersects any of the one or more second outlet openings.

In some implementations, the one or more first flow channels are not in fluid communication with the one or more second flow channels.

In some implementations, the device further includes a flow separator having a first side, a second side opposite and spaced apart from the first side of the flow separator, a first end, and a second end opposite and spaced apart from the first end of the flow separator. The second side of the first shim plate is coupled to the first side of the flow separator, and the second side of the flow separator is coupled to the first side of the second shim plate.

In some implementations, the device further includes a first flow divider and a second flow divider. The first flow divider has a first side, a second side opposite and spaced apart from the first side of the first flow divider, a first end, and a second end opposite and spaced apart from the first end of the first flow divider. The first side of the first flow divider defines a first divider opening extending from the first side of the first flow divider to the second side of the first flow divider.

The second flow divider has a first side, a second side opposite and spaced apart from the first side of the second flow divider, a first end, and a second end opposite and spaced apart from the first end of the second flow divider. The first side of the second flow divider defines a second divider opening extending from the first side of the second flow divider to the second side of the second flow divider.

The second side of the first flow divider is coupled to the first side of the first shim plate such that the first divider opening is in fluid communication with each of the one or more first flow channels. The second side of the second shim plate is coupled to the first side of the second flow divider such that the second divider opening is in fluid communication with each of the one or more second flow channels.

In some implementations, the device further includes a first inlet plate and a second inlet plate. The first inlet plate has a first side, a second side opposite and spaced apart from the first side of the first inlet plate, a first end, and a second end opposite and spaced apart from the first end of the first inlet plate. The first side of the first inlet plate defines a first inlet port extending from the first side of the first inlet plate to the second side of the first inlet plate.

The second inlet plate has a first side, a second side opposite and spaced apart from the first side of the second inlet plate, a first end, and a second end opposite and spaced apart from the first end of the second inlet plate. The first side of the second inlet plate defines a second inlet port extending from the first side of the second inlet plate to the second side of the second inlet plate.

The second side of the first inlet plate is coupled to the first side of the first flow divider such that the first inlet port is in fluid communication with each of the one or more first flow channels. The second side of the second flow divider is coupled to the first side of the second inlet plate such that the second inlet port is in fluid communication with each of the one or more second flow channels.

Each of the first inlet plate, the first flow divider, the first shim plate, the flow divider, the second shim plate, the second flow divider, and the second inlet plate include at least one fastener opening for coupling the first inlet plate, the first flow divider, the first shim plate, the flow divider, the second shim plate, the second flow divider, and the second inlet plate to each other.

In some implementations, the device further includes a first pressure regulator and a second pressure regulator. The first pressure regulator is in fluid communication with the one or more first flow channels and is configured to regulate the pressure of a first fluid to the first flow channels. The second pressure regulator is in fluid communication with the one or more second flow channels and is configured to regulate the pressure of a second fluid to the one or more second flow channels.

In some implementations, the device further includes a computer numerical control (CNC) machine coupled to the first and second shim plates.

In some implementations, the first fluid and the second fluid each comprise an ion conductor.

### BRIEF DESCRIPTION OF DRAWINGS

Example features and implementations are disclosed in the accompanying drawings. However, the present disclosure is not limited to the precise arrangements and instrumentalities shown.

FIG. 1 is a side and bottom end view of a coextrusion device, according to one implementation.

FIG. 2 is an exploded view of the plates included in the coextrusion device of FIG. 1.

FIG. 3 is various shim plates used in coextrusion devices, according to some implementations.

FIG. 4 is a edge view of the coextrusion device of FIG. 1.

FIG. 5 is a schematic view of a system including the coextrusion device of FIG. 1.

FIG. 6a is a graph of the ionic conductivity of coextruded membranes.

FIG. 6b is a graph of the transference number of coextruded membranes.

FIG. 6c is a graph of the ionic conductivity and transference number of membrane processed using direct write protocol.

FIG. 7a is a schematic diagram of Li ion transport in hybrid electrolytes with ion transport mechanisms and characteristic time-scales.

FIG. 7b is an effective mean field theory model for estimating interfacial properties.

FIG. 7c is a graph of the distribution of relaxation time results for all samples.

FIG. 7d is a graph of the EMFT results for CoX_1 mm membrane with 25 wt. % and 75 wt. % system as the bounding components.

FIG. 7e is a graph of interfacial conductivities for all samples.

FIG. 8a is the Li ion flux distribution through a planar section of coextruded membrane. Flux at the interface along the transverse section is also shown.

FIG. 8b is a graph of the normalized Li ion flux across the width of the coextruded membrane studied using simulations.

### DETAILED DESCRIPTION

Various implementations include a coextrusion device. The device includes a first shim plate and a second shim plate. The first shim plate has a first side, a second side opposite and spaced apart from the first side of the first shim plate, a first end, and a second end opposite and spaced apart from the first end of the first shim plate. The second end of the first shim plate defines one or more first outlet openings. A first flow channel extends from each of the one or more first outlet openings and extends along a centralized first axis from the second end of the first shim plate toward the first end of the first shim plate.

The second shim plate is coupled to the first shim plate. The second shim plate has a first side, a second side opposite and spaced apart from the first side of the second shim plate, a first end, and a second end opposite and spaced apart from the first end of the second shim plate. The second end of the second shim plate defines one or more second outlet openings. The second flow channel extends from each of the one or more second outlet openings and extends along a centralized second axis from the second end of the second shim plate toward the first end of the second shim plate.

A first central plane extends perpendicular to the first side of the first shim plate and along each of the centralized first axes, and a second central plane extends perpendicular to the first side of the second shim plate and along each of the centralized second axes. The first central planes and second central planes intersect an axis perpendicular to the first central planes and second central planes and are spaced apart from each other.

Various other implementations include a method of coextruding a solid electrolyte film. The method includes positioning a coextrusion device above a surface; introducing a first fluid into each of the first flow channels such that the first fluid flows through the first flow channels, out of the one or more first outlet openings, and onto the surface; introducing a second fluid into each of the second flow channels such that the second fluid flows through the second flow channels, out of the one or more second outlet openings, and onto the surface; and moving the device in a direction parallel to the surface.

The device includes a first shim plate and a second shim plate. The first shim plate has a first side, a second side opposite and spaced apart from the first side of the first shim plate, a first end, and a second end opposite and spaced apart from the first end of the first shim plate. The second end of the first shim plate defines one or more first outlet openings. A first flow channel extends from each of the one or more first outlet openings and extends along a centralized first axis from the second end of the first shim plate toward the first end of the first shim plate.

The second shim plate is coupled to the first shim plate. The second shim plate has a first side, a second side opposite and spaced apart from the first side of the second shim plate, a first end, and a second end opposite and spaced apart from the first end of the second shim plate. The second end of the second shim plate defines one or more second outlet openings. The second flow channel extends from each of the one or more second outlet openings and extends along a centralized second axis from the second end of the second shim plate toward the first end of the second shim plate.

A first central plane extends perpendicular to the first side of the first shim plate and along each of the centralized first axes, and a second central plane extends perpendicular to the first side of the second shim plate and along each of the centralized second axes. The first central planes and second central planes intersect an axis perpendicular to the first central planes and second central planes and are spaced apart from each other.

Disclosed herein is a coextrusion device for extruding two ion conductor fluids in parallel strips. Also disclosed is a method for coextruding the two fluids using the coextruding device. The coextruded strips can be used in solid state batteries, as discussed below.

Lithium metal based all-solid-state batteries (“ASSBs”) can achieve high energy densities due their high theoretical capacities (3860 mAh/g) and low reduction potential (3.04 V). Solid electrolytes can be broadly classified into two material categories (1) organic and (2) inorganic. The benefits of organic solid electrolytes are that they are easy to manufacture into thin films and are mechanically robust and flexible. However, these materials possess low ionic conductivities in comparison to inorganic alternatives. Inorganic ceramic and glass-type solid electrolytes possess high ionic conductivity, mechanical strength, and electrochemical stability and are suitable alternative to organic solid electrolytes as an electrolyte material in ASSBs. Gravimetric calculations show that electrolytes with ≤60 μm thickness need to be manufactured to achieve competitive energy densities. Processing thin, high density ceramic electrolytes in these form factors is challenging considering the need to merge with existing battery manufacturing infrastructure. Hybrid electrolytes combine an inorganic conductor with a polymer electrolyte which improves the mechanical properties and limits dendrite growth in metal batteries.

The ionic conductivity is lower in hybrid electrolytes than inorganic electrolytes. This “hybrid penalty” arises from the presence of interfaces in the material. Intrinsic interfaces within the hybrid electrolyte exists at the polymer-particle junction. Nanoionics refers to the indirect effects caused by the local migration of mobile ions at solid-solid heterogeneous interfaces. The physics of mass transfer, transport, and storage at these interfaces is largely governed by the formation of a space charge layer. Space charge layers commonly form at grain boundaries in polycrystalline ceramic ion conductors and at metal-electrode interfaces. This layer is analogous to the electric double layer that forms at solid-liquid interfaces and can result in regions with higher or lower ionic conductivities.

The addition of oxide particles to the polymer matrix leads to Lewis acid-base interactions in the vicinity of the particles. This leads to well dissociated lithium salts that can increase the free Li+ ion concentration in the vicinity of the particles. Additionally, interactions between the polymer and particles leads to lowered crystallinity of the polymer phase which improves the ion transport properties of the polymer. Probing Li ion transport by solid state NMR has shown that ion transport pathways are strongly dependent on the composition of the electrolyte. Lithium ions are shown to prefer the plasticizer phase for systems containing them, ceramic phase in some systems, and transitions from polymer phase to ceramic phase with some systems. Anion and cation motion through a representative polymer-ceramic composite show marked differences. Ceramic electrolytes have a lithium ion transference number close to one that blocks all anion transport. This leads to redistribution of anions over the particles and leads to higher effective current densities through the interfacial region. Effective mean field theory, as well as experimental studies, reinforce that the intrinsic interfaces within the system possess ion transport properties that are disparate from the polymer and the ceramic phase. The nano-scale nature of these interfaces makes it experimentally difficult to probe the nature and impact of these interfaces on ion transport. The ability to engineer macro-scale interfaces can provide a viable way to study these processes.

Scalable production of the solid electrolyte is one of the key challenges currently facing solid state battery technology. Separator production for liquid electrolyte-based lithium batteries was close to 2.7×10⁶ m² in 2018. A non-intrusive technology is required for scalable production of solid electrolytes that can merge in the existing supply chain for market penetration of ASSBs. Conventionally, hybrid electrolytes are processed from a homogenized dispersion of polymer, lithium salt, and the ceramic filler. This dispersion is solution-casted on a PTFE or teflon substrate to obtain free standing films. Electrolytes produced by these methods show ionic conductivity of around 10⁻⁴ S/cm. Moving from a spherical particle filler to nano-wires has shown an improvement in ion transport properties as well as rate capabilities of these hybrid electrolytes. Changing the morphology of the conducting inorganic filler modifies the polymer properties in the vicinity of the particles improving the overall transport. This has been further extended to develop 3D garnet-polymer frameworks that aim to tailor ion transport through the hybrid electrolyte. These 3D frameworks show excellent mechanical and electrochemical properties while maintaining high ion transport properties. The major challenge with tailoring microstructure in hybrid electrolytes is the uncertainty regarding the ion transport pathways. Contradicting reports suggest Li ions favoring the ceramic phase, the polymer phase, or the interface region. Additionally, the prior art routes undertaken to develop 3D frameworks for these electrolytes are not scalable.

Controlling generation of interfaces during production can allow for the tailoring of ion transport pathways as well as improving ion transport properties. Tailoring the composition of hybrid electrolytes and their intrinsic interfaces can provide a route to scalable, high-performance material systems. Engineering solid electrolytes with controlled transport pathways and uniform concentration gradients mitigates degradation phenomena accelerated by the formation of local hot spots (i.e. Li excess/deficient regions). The devices, systems, and methods disclosed herein provide a manufacturing platform to explore the roll material interfaces play on transport.

This method employs a novel slot-die coextrusion device that enables scalable production of electrolytes within the conventional battery manufacturing infrastructure. This technique is versatile and can enable control over material composition, density, and structure during roll-to-roll scale processing.

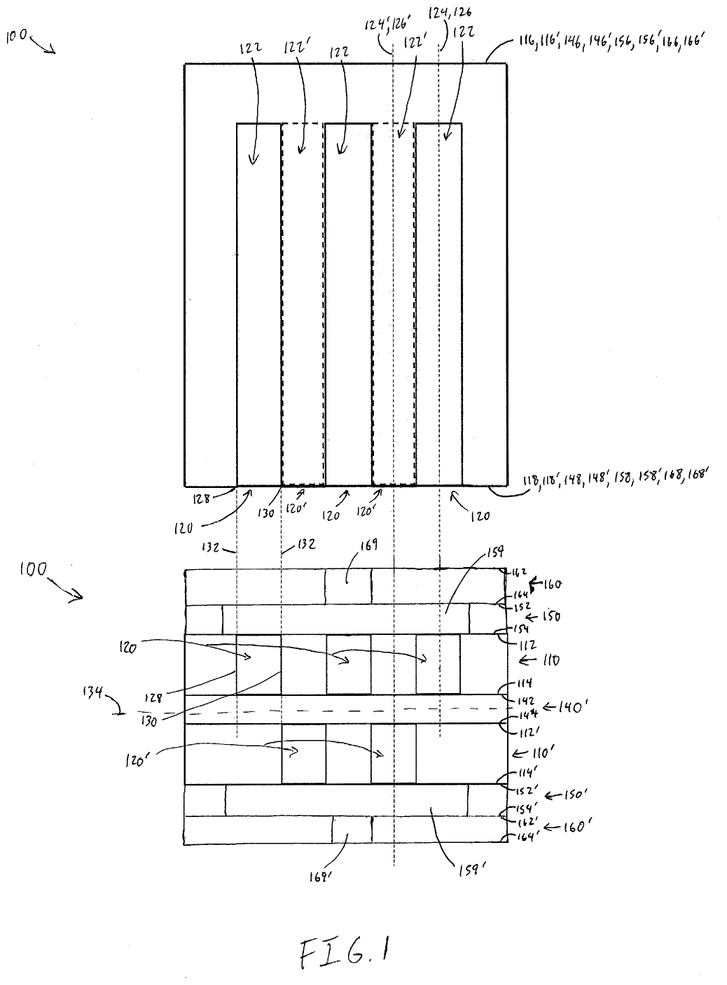

FIGS. 1-5 show the coextrusion device 100. The device 100 includes a first inlet plate 160, a first flow divider 150, a first shim plate 110, a flow separator 140, a second shim plate 110′, a second flow divider 150′, and a second inlet plate 160′.

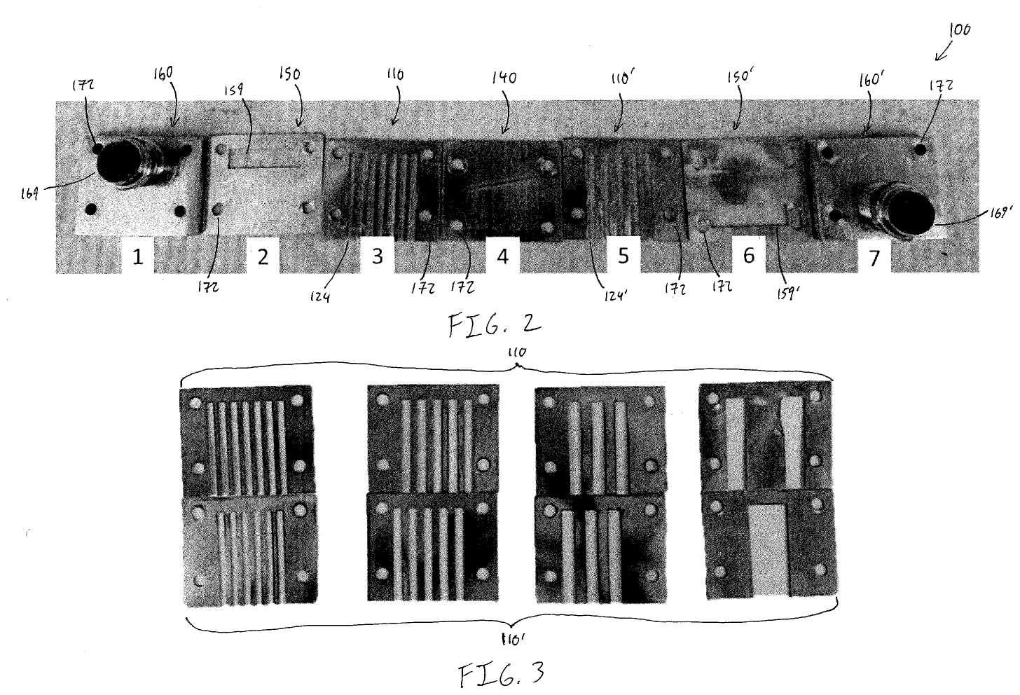

The first shim plate 110 has a first side 112, a second side 114 opposite and spaced apart from the first side 112 of the first shim plate 110, a first end 116, and a second end 118 opposite and spaced apart from the first end 116 of the first shim plate 110. The second end 118 of the first shim plate 110 defines one or more first outlet openings 120, and a first flow channel 122 extends from each of the one or more first outlet openings 120. Each first flow channel 122 extends along a centralized first axis 124 from the first outlet openings 120 at the second end 118 of the first shim plate 110 toward the first end 116 of the first shim plate 110. The first shim plates 110 shown in FIGS. 2 and 3 each include four fastener openings 172 defined by the first side 112 of the first shim plate 110 and extending to the second side 114 of the first shim plate 110. The four fastener openings 172 are for coupling the first shim plate 110 to the other plates, and each fastener opening 172 is aligned with a fastener opening 172 in each of the other plates, as described below. However, in other implementations, the first shim plate includes any number of one or more fastener openings.

Although the first shim plate 110 shown in FIG. 1 includes three first flow channels 122 extending from three first outlet openings 120, and the first shim plate 110 shown in FIG. 2 includes seven first flow channels 122 extending from seven first outlet openings 120, in other implementations, the first shim plate includes any number of first outlet openings and first flow channels. For example, FIG. 3 shows various implementations of first shim plates 110 that include seven, five, three, and two first outlet openings 120 and first flow channels 122.

The second shim plate 110′ has a first side 112′, a second side 114′ opposite and spaced apart from the first side 112′ of the second shim plate 110′, a first end 116′, and a second end 118′ opposite and spaced apart from the first end 116′ of the second shim plate 110′. The second end 118′ of the second shim plate 110′ defines one or more second outlet openings 120′, and a second flow channel 122′ extends from each of the one or more second outlet openings 120′. Each second flow channel 122′ extends along a centralized second axis 124′ from the second outlet openings 120′ at the second end 118′ of the second shim plate 110′ toward the first end 116′ of the second shim plate 110′. The second shim plates 110′ shown in FIGS. 2 and 3 each include four fastener openings 172′ defined by the first side 112′ of the second shim plate 110′ and extending to the second side 114′ of the second shim plate 110′. The four fastener openings 172′ are for coupling the second shim plate 110′ to the other plates, and each fastener opening 172′ is aligned with a fastener opening 172′ in each of the other plates, as described below. However, in other implementations, the second shim plate includes any number of one or more fastener openings.

Although the second shim plate 110′ shown in FIG. 1 includes two second flow channels 122′ extending from two second outlet openings 120′, and the second shim plate 110′ shown in FIG. 2 includes seven second flow channels 122′ extending from seven second outlet openings 120′, in other implementations, the second shim plate includes any number of second outlet openings and second flow channels. For example, FIG. 3 shows various implementations of second shim plates 110′ that include six, five, three, and one second outlet openings 120′ and second flow channels 122′.

In use, a first fluid 170 is introduced into each of the first flow channels 122 of the first shim plate 110, and a second fluid 170′ is introduced into each of the second flow channels 122′ of the second shim plate 110′. The first and second fluids 170, 170′ flow through the first and second flow channels 122, 122′, respectively, and out of the first and second outlet openings 120, 120′, respectively.

Each of the first flow channels 122 includes a first central plane 126 extending along each of the centralized first axes 124 and perpendicular to the first side 112 of the first shim plate 110. Each of the second flow channels 122′ includes a second central plane 126′ extending along each of the centralized second axes 124′ and perpendicular to the first side 112 of the second shim plate 110′. Each of the first central planes 126 and second central planes 126′ are parallel to each other and are intersected by an axis 134 perpendicular to the first central planes 126 and second central planes 126′. Each of the first central planes 126 and second central planes 126′ are spaced apart from each other.

As seen in FIGS. 1-3, each of the first outlet openings 120 has a first edge 128 and a second edge 130 that are opposite and spaced apart from each other. An edge plane 132 extends along each of the first edges 128 and second edges 130, and none of the edge planes 132 intersect any of the one or more second outlet openings 120′. Because none of the edge planes 132 intersect any of the one or more second outlet openings 120′, the fluid 170 flowing out of the first outlet openings 120 will not overlap with the fluid 170′ flowing out of any of the second outlet openings 120′ when the device 100 is in use, as described below.

The number of first flow channels 122 and second flow channels 122′ and the lengths and widths of each of the first flow channels 122 and the second flow channels 122′ are determined by the desired final product, as discussed below. Although the first flow channels 122 and second flow channels 122′ shown in FIGS. 1-3 extend along straight first centralized axes 124 and second centralized axes 124′, respectively, and are uniform in width along their respective centralized axes 124, 124′, in some implementations, the first centralized axes and second centralized axes are any shape and the widths of the first centralized axes and second centralized axes can vary along their respective centralized axes. Although the first flow channels 122 and second flow channels 122′ shown in FIGS. 1-3 extend from the first sides 112, 112′ to the second sides 114, 114′ of the first shim plate 110 and second shim plate 110′, respectively, in other implementations, the flow channels only extend partially from one of the first side or second side of a shim plate to the other of the first side or second side of the shim plate or may extend from the second end of a shim plate without extending to either side of the shim plate.

The shim plates 110, 110′ shown in FIGS. 1-3 are manufactured from steel. However, in other implementations, the shim plates are manufactured from any other material that will not deform from the pressure of fluid being introduced through the flow channels and will not be reactive with the fluids introduced into the flow channels.

The purpose of the flow separator 140 is to prevent the first and second fluids 170, 170′ flowing through the first and second flow channels 122, 122′, respectively, from being in fluid communication with each other. The flow separator 140 has a first side 142, a second side 144 opposite and spaced apart from the first side 142 of the flow separator 140, a first end 146, and a second end 148 opposite and spaced apart from the first end 146 of the flow separator 140. The flow separator 140 shown in FIG. 2 includes four fastener openings 172 defined by the first side 142 of the flow separator 140 and extending to the second side 144 of the flow separator 140. The four fastener openings 172 are for coupling the flow separator 140 to the other plates, and each fastener opening 172 is aligned with a fastener opening 172 in each of the other plates, as described below. However, in other implementations, the flow separator includes any number of one or more fastener openings. In implementations in which the flow channels 122 do not extend fully through the shim plate from the first side 112, 112′ to the second side 114, 114′, a flow separator 140 may not be necessary so long as the first and second fluids 170, 170′ are not in fluid communication with each other.

The flow separator 140 shown in FIGS. 1 and 2 is manufactured from steel. However, in other implementations, the flow separator is manufactured from any other material that will not deform from the pressure of fluid being introduced through the flow channels and will not be reactive with the first and second fluids.

The purpose of the first and second flow dividers 150, 150′ is to distribute the fluids 170, 170′ uniformly between each of the first flow channels 122 and second flow channels 122′, respectively. The first flow divider 150 has a first side 152, a second side 154 opposite and spaced apart from the first side 152 of the first flow divider 150, a first end 156, and a second end 158 opposite and spaced apart from the first end 156 of the first flow divider 150. The first side 152 of the first flow divider 150 defines a first divider opening 159 extending from the first side 152 of the first flow divider 150 to the second side 154 of the first flow divider 150. The first divider opening 159 is sized to be in fluid communication with each of the first flow channels 122 and is configured to distribute the first fluid 170 into each of the first flow channels 122. The first divider opening 159 shown in FIGS. 1 and 2 is sized to distribute the first fluid 170 into each of the first flow channels 122 at an equal pressure and flowrate.

The first flow divider 150 shown in FIG. 2 includes four fastener openings 172 defined by the first side 152 of the first flow divider 150 and extending to the second side 154 of the first flow divider 150. The four fastener openings 172 are for coupling the first flow divider 150 to the other plates, and each fastener opening 172 is aligned with a fastener opening 172 in each of the other plates, as described below. However, in other implementations, the first flow divider includes any number of one or more fastener openings.

The first flow divider 150 shown in FIGS. 1 and 2 is manufactured from steel. However, in other implementations, the first flow divider is manufactured from any other material that will not deform from the pressure of fluid being introduced through the first divider opening and will not be reactive with the fluids introduced into the first divider opening.

The second flow divider 150′ has a first side 152′, a second side 154′ opposite and spaced apart from the first side 152′ of the second flow divider 150′, a first end 156′, and a second end 158′ opposite and spaced apart from the first end 156′ of the second flow divider 150′. The first side 152′ of the second flow divider 150′ defines a second divider opening 159′ extending from the first side 152′ of the second flow divider 150′ to the second side 154′ of the second flow divider 150′. The second divider opening 159′ is sized to be in fluid communication with each of the second flow channels 122′ and is configured to distribute the second fluid 170′ into each of the second flow channels 122′. The second divider opening 159′ shown in FIGS. 1 and 2 is sized to distribute the second fluid 170′ into each of the second flow channels 122′ at an equal pressure and flowrate.

The second flow divider 150′ shown in FIG. 2 includes four fastener openings 172 defined by the first side 152′ of the second flow divider 150′ and extending to the second side 154′ of the second flow divider 150′. The four fastener openings 172 are for coupling the second flow divider 150′ to the other plates, and each fastener opening 172 is aligned with a fastener opening 172 in each of the other plates, as described below. However, in other implementations, the second flow divider includes any number of one or more fastener openings.

The second flow divider 150′ shown in FIGS. 1 and 2 is manufactured from steel. However, in other implementations, the second flow divider is manufactured from any other material that will not deform from the pressure of fluid being introduced through the second divider opening and will not be reactive with the fluids introduced into the second divider opening.

The purpose of the inlet plates 160, 160′ is to provide a means for coupling the device 100 to a fluid source. The first inlet plate 160 has a first side 162, a second side 164 opposite and spaced apart from the first side 162 of the first inlet plate 160, a first end 166, and a second end 168 opposite and spaced apart from the first end 166 of the first inlet plate 160. The first side 162 of the first inlet plate 160 defines a first inlet port 169 extending from the first side 162 of the first inlet plate 160 to the second side 164 of the first inlet plate 160. The first inlet port 169 is sized to be in fluid communication with the first divider opening 159 and is configured to distribute the first fluid 170 into the first divider opening 159. Thus, the first inlet port 169 is in fluid communication with each of the first flow channels 122 via the first divider opening 159. The first inlet port 169 shown in FIGS. 1 and 2 includes a standard quick-connect pipe fitting for coupling the first inlet port 169 to a first fluid tube, but in other implementations, the first inlet port can include any other fastener to couple the first inlet port to the first fluid tube.

The first inlet plate 160 shown in FIG. 2 includes four fastener openings 172 defined by the first side 162 of the first inlet plate 160 and extending to the second side 164 of the first inlet plate 160. The four fastener openings 172 are for coupling the first inlet plate 160 to the other plates, and each fastener opening 172 is aligned with a fastener opening 172 in each of the other plates, as described below. However, in other implementations, the first inlet plate includes any number of one or more fastener openings.

The first inlet plate 160 shown in FIGS. 1 and 2 is manufactured from steel. However, in other implementations, the first inlet plate is manufactured from any other material that will not deform from the pressure of fluid being introduced through the first inlet port and will not be reactive with the fluids introduced into the first inlet port.

The second inlet plate 160′ has a first side 162′, a second side 164′ opposite and spaced apart from the first side 162′ of the second inlet plate 160′, a first end 166′, and a second end 168′ opposite and spaced apart from the first end 166′ of the second inlet plate 160′. The first side 162′ of the second inlet plate 160′ defines a second inlet port 169′ extending from the first side 162′ of the second inlet plate 160′ to the second side 164′ of the second inlet plate 160′. The second inlet port 169′ is sized to be in fluid communication with the second divider opening 159′ and is configured to distribute the second fluid 170′ into the second divider opening 159′. Thus, the second inlet port 169′ is in fluid communication with each of the second flow channels 122′ via the second divider opening 159′. The second inlet port 169′ shown in FIGS. 1 and 2 includes a standard quick-connect pipe fitting for coupling the second inlet port 169′ to a second fluid tube, but in other implementations, the second inlet port can include any other fastener to couple the second inlet port to the second fluid tube.

The second inlet plate 160′ shown in FIG. 2 includes four fastener openings 172 defined by the first side 162′ of the second inlet plate 160′ and extending to the second side 164′ of the second inlet plate 160′. The four fastener openings 172 are for coupling the second inlet plate 160′ to the other plates, and each fastener opening 172 is aligned with a fastener opening 172 in each of the other plates, as described below. However, in other implementations, the second inlet plate includes any number of one or more fastener openings.

The second inlet plate 160′ shown in FIGS. 1 and 2 is manufactured from steel. However, in other implementations, the second inlet plate is manufactured from any other material that will not deform from the pressure of fluid being introduced through the second inlet port and will not be reactive with the fluids introduced into the second inlet port.

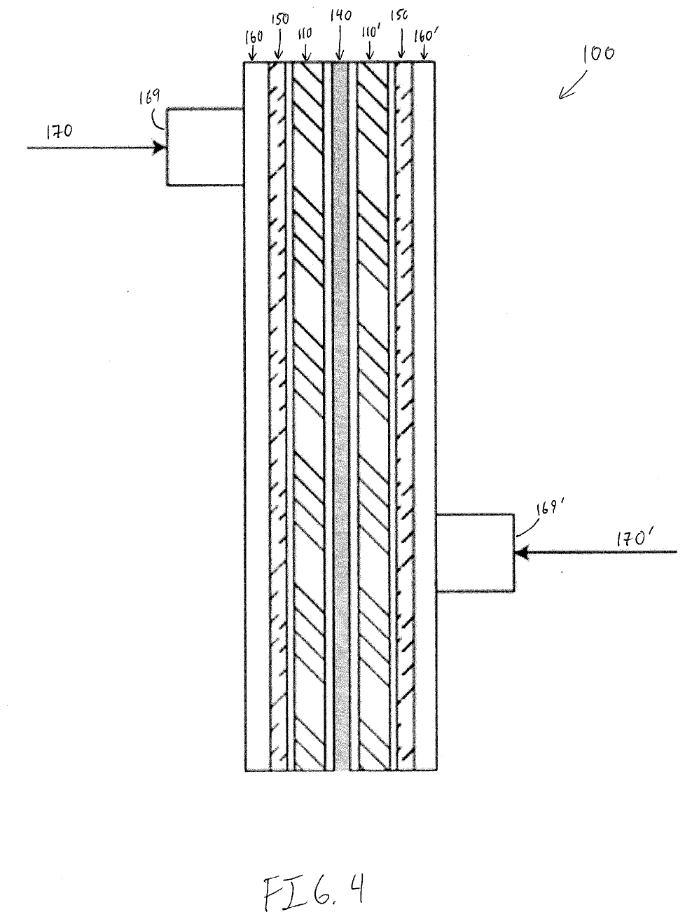

As shown in FIGS. 1 and 4, the plates are assembled as follows: the second side 164 of the first inlet plate 160 is coupled to the first side 152 of the first flow divider 150, the second side 154 of the first flow divider 150 is coupled to the first side 112 of the first shim plate 110, the second side 114 of the first shim plate 110 is coupled to the first side 142 of the flow separator 140, the second side 144 of the flow separator 140 is coupled to the first side 112′ of the second shim plate 110′, the second side 114′ of the second shim plate 110′ is coupled to the first side 152′ of the second flow divider 150′, and the second side 154′ of the second flow divider 150′ is coupled to the first side 162′ of the second inlet plate 160′. Each of the fastener openings 172 in each of the plates aligns with one of the fastener openings 172 in each of the other plates. A fastener is inserted through each set of aligned fastener openings 172 and is fastened to couple the plates together. When the plates are coupled together, the abutting faces of the plates form a seal to prevent the fluids 170, 170′ from flowing between the plates. Although the plates shown in FIGS. 1 and 4 are coupled to each other using fasteners, in other implementations, the plates are fastened in any other way capable of withstanding the pressure of the fluids introduced through the inlet ports, divider openings, and flow channels and maintaining a seal between the plates.

The first fluid 170 and the second fluid 170′ each comprise an ion conductor. The fluids 170, 170′ can comprise a combination of a solvent and an organic ion conductor, a salt, a plasticizer, and/or an inorganic ion conductor. However, either organic or inorganic ion conductor should be present in the solvent. The rest of the components of the fluids 170, 170′ can be added to the mixture based on the requirements of the system. Examples of typical materials used in a system are shown below in Table 1. In addition to inorganic ion conductors, inorganic fillers can also be used in hybrid electrolyte systems. Examples of inorganic fillers include metal oxides particles (e.g., Al₂O₃, ZrO₂), silica particles, and clay particles, among others. Various combinatorial mixtures of the fluid system are possible and new materials for ion conduction can be synthesized and included through material chemistry.

TABLE 1

| Organic Ion Conductors: | Salts: | Inorganic Materials: | Plasticizers: |
|---|---|---|---|
| PEO | LiBr | LATP | TEGDME |
| PVC | LiN3 | LLZO | Ethylene/Proplyene |
| PAN | LiCl | LGPS | Carbonate |
| PMMA | LiF | LIPON | PEGDME |
| PVDF | LiPF6 | LiO3Cl | Epoxidized natural |
| PVDF-HFP | LiClO4 | | rubber |
| PPG | CF3SO3Li | | |
| PDMS | | | |
| PEC | | | |
| PPC | | | |
| PCL | | | |
| PTMC | | | |

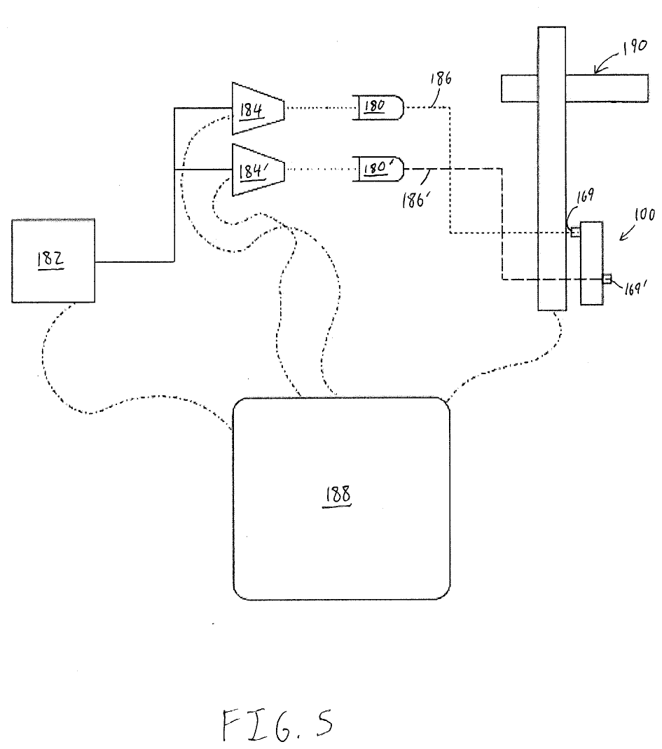

FIG. 5 shows a diagram of the fluid flow of the coextrusion device 100. First and second fluids 170, 170′ are pneumatically fed from a first fluid reservoir 180 and a second fluid reservoir 180′, respectively, to the coextrusion device 100. A pressure dosing system 182 provides a constant pressure source between 0-100 psi to a first pressure regulator 184 and a second pressure regulator 184′. The first pressure regulator 184 is in fluid communication with the first fluid reservoir 180, and the second pressure regulator 184′ is in fluid communication with the second fluid reservoir 180′. The first fluid reservoir 180 is fluidly coupled to the first inlet port 169 via a first fluid conduit 186, and the second fluid reservoir 180′ is fluidly coupled to the second inlet port 169′ via a second fluid conduit 186′. A controller 188 is used to control the pressure provided by the first and second pressure regulators 184, 184′, and thus, to control the pressure and flowrate of the first and second fluids 170, 170′ to the first and second inlet ports 169, 169′, respectively. The pressures applied by the pressure regulators 184, 184′ are correlated to the mass flow rates of respective fluids 170, 170′ and can be controlled independently. The dispensing pressures are informed by standard simulations and subsequently validated by test runs on the system.

The device 100 is coupled to a computer numerical control (“CNC”) machine 190 capable of XY-motion. The coating height is adjusted by moving the substrate. The CNC machine 190 has a resolution of ±50, ±150, and ±10 μm in the X-, Y- and Z-direction. Maximum coating speeds of 1.5 m/min are achieved. Standard G-codes are used for control of the coextrusion device 100 during coating.

In use, the CNC machine 190 positions the coextrusion device 100 above a surface. The controller 188 sends a signal to the first pressure regulator 184 to cause the first fluid 170 to flow from the first fluid reservoir 180, through the first fluid conduit 186, and into the first inlet port 169 of the first inlet plate 160. The first fluid 170 flows from the first inlet port 169, through the first flow divider 150, into each of the first flow channels 122, and out of the first outlet openings 120. The controller 188 also sends a signal to the second pressure regulator 184′ to cause the second fluid 170′ to flow from the second fluid reservoir 180′, through the second fluid conduit 186′, and into the second inlet port 169′ of the second inlet plate 160′. The second fluid 170′ flows from the second inlet port 169′, through the second flow divider 150′, into each of the second flow channels 122′, and out of the second outlet openings 120′. As the first and second fluids 170, 170′ are extruded from the first and second outlet openings 120, 120′, respectively, the first and second fluids 170, 170′ are deposited onto the surface in the pattern of the first and second outlet openings 120, 120′. The CNC machine 190 moves the coextrusion device 100 parallel to the surface to create strips of the first and second fluids 170, 170′ along the surface. Thus, the coextrusion device 100 is capable of extruding two layers in a single pass. Because the edge planes 132, 132′ extending along each of the first edges 128 and second edges 130 of each of the first outlet openings 120 do not intersects any of the second outlet openings 120′, the first and second fluids 170, 170′ do not overlap each other as they are extruded from the first and second outlet openings 120, 120′, respectively. Multiple shapes and layers of the first and second fluids 170, 170′ can be created.

The controller 188 uses an integrated software platform to integrate the positioning and feed of the coextrusion device 100. G-codes are generated by a script that takes user inputs of the coating lengths and number of coatings required. These are input to the software along with dispensing parameters for the fluids 170, 170′. The response delays of each system component are considered in designing the software. The software can deliver continuous as well as intermittent coating of the fluids 170, 170′ over the entire surface.

The coextrusion device 100 can work with a wide range of material systems and versatile applications. Primary applications are scalable coatings of functionally graded layers for electrochemical applications. One application of the coextrusion device 100 is to manufacture composite solid electrolytes. The methods disclosed herein allow for scalable fabrications of highly tunable architectures of solid electrolytes that promote ion transport and stability. This can be achieved by tailoring the composition of the fluids 170, 170′ in terms of polymer and ceramic content as well as additives. Fuel cell electrodes with tailored architectures to promote gas and liquid transport allow for scalable production with this technique. This can be achieved by (i) alternating hydrophobic and hydrophilic layers in plane by varying the polymer in the fluids 170, 170′ and (ii) controlling porosity in the through plane direction to enable effective mass transport through the electrode by varying the polymer content in two fluids 170, 170′. The coextrusion device 100 can also be used for battery electrodes with functional gradation using similar principles to optimize the mass transport. Additional applications include membranes for separation processes, polymer-based solar cell components, and electrolyzer components. The coextrusion device 100 is readily compatible with existing R2R lines that are being used for production of commercial electrochemical systems, reducing the market entry costs.

### Examples

Single material films and coextruded films with 1 mm (CoX_1 mm), 2 mm (CoX_2 mm) and 3 mm (CoX_3 mm) striped architecture were evaluated. Coextruded electrolytes show a clear advantage over single material films, which is attributed to the generation of highly conducting intrinsic interfaces within the hybrid electrolytes. The beneficial nature of these coextruded interfaces is identified using relaxation time distribution of charge transport mechanisms. This is validated by theoretical modelling of the hybrid system using effective mean field theory as well as computational fluid dynamics Coextrusion processing with control over local architectures enables scalable production of high-performance solid electrolytes.

A stable coating is obtained when the pressure inside the coating bead is balanced by the ambient conditions. If the pressure inside the bead is too large, the fluid swells out in all directions leading to a defect called leaking. This defect leads to loss of control over the coating width and thickness. At the other extreme, if the pressure in the bead is too low, air can be entrained in the film at the upstream meniscus leading to a breakup of the coating bead. The defect begins at isolated spots, and it can deteriorate into uncoated streaks if it deteriorates further. Finally, at very high web speeds the downstream meniscus cannot maintain contact with the web and leads to uncoated regions from the downstream lip. It should be noted that this defect will appear through the width of the slot and can manifest as ribbing/ripples in the coating. To ensure a uniform pressure distribution at the outlet openings, the flow dividers and the shims are designed using computational fluid dynamics simulations as a design tool. Flow divider geometry and shim configurations are designed to achieve a uniform pressure distribution at the outlet openings. The fluids used for coextrusion show shear thinning behavior and have unstructured agglomerates. It should be noted that all these individual configurations can be obtained in a single pass coating.

The configurations are selected to create hybrid electrolytes with interfaces between a low ceramic containing matrix and a high ceramic loaded matrix. Coextruded membranes show a higher conductivity in general compared to single material films, as shown in FIG. 6a. The coextruded films show similar conductivity values, with the film containing a 1 mm striped architecture showing the highest conductivity. The striped architecture resembles a parallel conductor network for which the equivalent conductance is equal to the sum of individual conductance in the circuit. Charges are redistributed through the individual stripes to minimize the voltage drop across the system. However, it should be noted that the equivalent circuit model described above considers electron motion which is not the case for the hybrid electrolytes. Ion transport through the electrolyte are rate limited by kinetics of ion motion through the material. Increase of ionic conductivity for coextruded membranes suggest generation of regions within the electrolyte that possess better ion transport kinetics. This region can be identified as the interfacial region between the two material stripes. It is proposed that these interfacial regions generated through coextrusion possess better ion transport properties and lead to an increase in ionic conductivity of the coextruded membranes. To confirm the reliability of the coextrusion device, at least ten samples were measured for each sample from separately cast films for ionic conductivity and transference number measurement.

The transference number increases from 0.36 to 0.56 as the ceramic loading is increased from 25 wt. % to 75 wt. %. The transference number of the 25 wt. % systems is 0.36 while that of 75 wt. % system is 0.56, as shown in FIG. 6b. The 75 wt. % system represents a composition above the percolation threshold of ceramic filler in the polymer matrix. This suggests a percolated network of ceramic particles exists that improves the efficacy of Li ion transport through the hybrid electrolyte. The transference number for the coextruded electrolytes falls between these two systems. This suggests that while the interfacial regions have improved ion transport kinetics, the efficacy of ion transport is not improved. Anion mobility is identically increased as the cation mobility leading to an averaged transference number compared to the bounding system. This additionally offers an insight about the material nature of the interfacial region generated. Since both anionic and cationic mobilities are effectively improved (as evidenced by transference number values falling between the two bounding systems), the interfacial region should possess polymers in a confined state that arise from a disparity of ceramic packing within the two material systems. FIG. 6c shows the ionic conductivity and transference number of a membrane processed using direct write protocol.

The direct write coating method is also capable of generating architectures similar to the coextrusion device. The important difference between this manufacturing approach and the coextrusion process is the absence of fluid interactions in the former. Direct write approach coats arrays of individual fluids one after the other while coextrusion coats both fluids at the same time. Thus, there is a possibility of mixing at the interfacial region in the latter case. Diffusion of components within the two fluid stripes during the drying step can also occur due to the composition difference between the two fluids. These phenomena have less impact with direct write coating process. The ionic conductivity of the electrolyte fabricated using the direct write approach (4.12*10⁻⁴ S/cm vs. 3.98*10⁻⁴ & 2.21*10⁻⁴ @ 75° C.) shows a slightly higher conductivity than the individual components as well as median transference number values. Coextruded electrolytes with a similar stripe configuration (2 mm) show slightly higher ionic conductivities (6.31*10⁻⁴ S/cm vs. 4.12*10⁻⁴ S/cm @ 75° C.) as well as smaller activation energies (0.966 eV vs. −1.06 eV). These results suggest that the macro-scale interfacial regions cause an improvement in the ion transport properties. Additionally, the coextrusion device generates interfaces with better transport properties due to the phenomena described above that may occur during coating and drying.

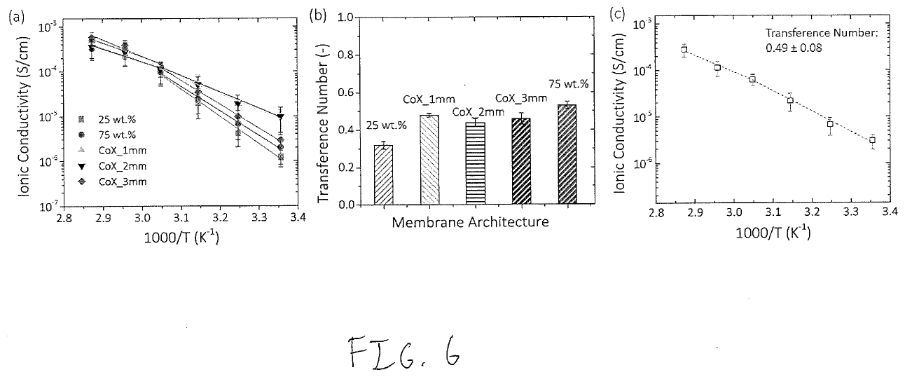

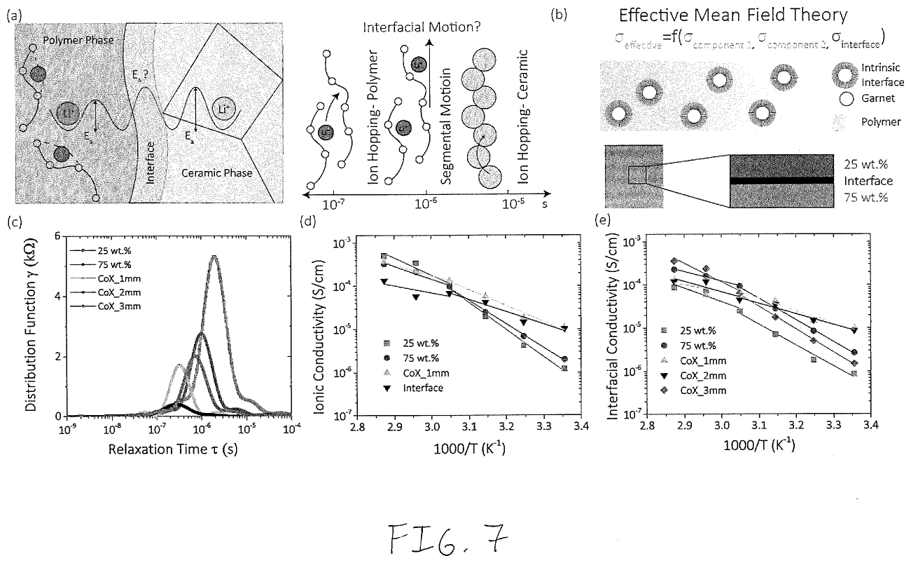

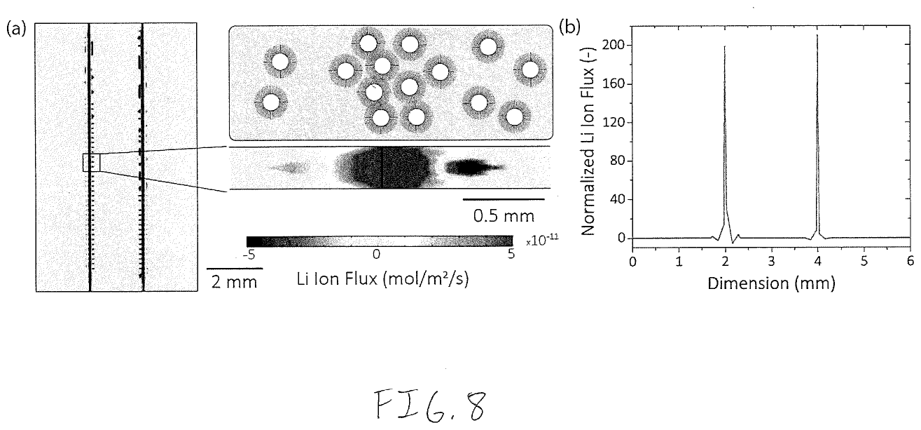

Ionic conductivity results show an improvement for samples containing macro-scale interfaces. Deconvoluting the ion transport mechanisms between the polymer phase, ceramic phase, and the interfacial region is a challenge. FIG. 7a shows a schematic diagram of Li ion transport in hybrid electrolytes with ion transport mechanisms and characteristic time-scales. Intra- and inter-chain ion hopping mechanisms, as well as segmental motion of the polymers, are known transport mechanisms through the polymer phase. Li ion transport in the garnet occurs primarily through hopping mechanisms that are driven by vacancy concentrations in the crystal structure. The improved ionic conductivity and median transference number suggest that the transport mechanisms at the interfacial regions are through a confined polymer matrix. Distribution of relaxation times analysis are employed as an experimental approach towards deconvoluting the ion transport mechanisms in these coextruded systems. This is complemented by theoretical modelling using effective mean field theory as well as 3-dimensional fluid dynamics simulations.

Distribution of relaxation time is a relatively less-known method for deconvoluting transport mechanisms from impedance spectra. The main advantage of this technique is that it does not require any a priori assumptions regarding the system behavior as is necessitated in equivalent circuit modelling of the impedance spectra. Furthermore, this technique allows for unambiguously resolving processes that contribute to the overall impedance with close time constants. The DRT spectra of 25 wt. % system shows two clear peaks around 10⁻⁷ s and around 4*10⁻⁶ s. These represent the two characteristic ion transport mechanisms in the polymer: inter- and intra-chain ion hopping and the segmental motion respectively. The ceramic concentration at this loading is around 7 vol. %, which suggests a discrete network that does not contribute to ion transport significantly. Moving to the 75 wt. % system results in diminishing of the peak around 10⁻⁷ s and emergence of a new peak around 6*10⁻⁵ s. The latter is characteristic of ion transport through the ceramic phase which forms a completely percolated network at this loading. Coextruded electrolytes all show a shift of peaks to lower relaxation times suggesting faster ion transport mechanisms. Additionally, features at very low relaxation times appear (10⁻⁷ s), which reinforces the idea of generation of regions of faster ion transport within the coextruded electrolytes. FIG. 7c shows a distribution of relaxation time results for all samples.

While distribution of relaxation times helps to show a presence of highly conducting regions, the physical properties of these regions are not quantifiable. Effective mean field theory (“EMFT”) has been employed to screen mixture compositions for hybrid electrolytes. EMFT models use conductivity values for individual components of a composite matrix, as well as the interface, to predict the properties of the composite matrix, as shown in FIG. 7b. This model is leveraged and used implicitly to solve for the interfacial properties. An assumption for very thin interfaces (compared to the particle radius) is taken to simplify the analysis. This approximation is fairly safe considering the length scales interface layer is expected to propagate from the particle surface. This model is employed to predict the properties of macro-scale interfaces generated in the coextruded samples. There are obvious limitations of applying this model to planar architectures seen in the coextruded electrolytes, but it offers a reasonable first estimate of the interfacial conductivities. The interfacial conductivities for all samples are shown in FIG. 7e.

The interface in the 25 wt. % system between the polymer phase and ceramic phase shows higher ionic conductivity at temperatures lower than the transition temperature of the polymer (55° C.). Ion transport favors the interface in this case over the polymer phase. At temperatures higher than this, the interface is less conductive, showing that Li ion moves through the bulk phase. A similar behavior is seen with the 75 wt. % system. The important difference between these two systems occurs above the transition temperature for a polymer. The interfacial conductivity shows a decay after 55° C. for the 75 wt. % system. Higher ceramic loading in this system possibly restricts the interfacial polymer to relax lowering the interfacial conductivity. The EMFT model predicts that the interfacial conductivity in a 1 mm striped coextruded electrolyte is higher than the ionic conductivity of 25 wt. % and 75 wt. % system, as shown in FIG. 7d. The ionic conductivity of the interfacial layer for this configuration is found to be slightly lower than the coextruded sample with slightly smaller activation energies, as shown in Table 2. Similar behavior is seen for the other coextruded samples. A sample with a 1 mm stripe architecture shows the highest interfacial conductivity and lower activation energies. Ion transport simulations carried out on a COMSOL simulation platform show strong localization of lithium ion flux at the interfacial region, as shown in FIG. 8a. The cross-section across the thickness of the electrolyte at the interface highlights the lithium ion distribution at the interfacial region for the coextruded architectures. Normalized flux across the entire width of the simulated domain show clear spikes in lithium ion flux at the interfacial region, as shown in FIG. 8b. Simulations show an enhancement factor of around 100× in the ion flux at the interfacial regions.

TABLE 2

| Branch | 25 wt. % | 75 wt. % | CoX_1 mm | CoX_2 mm | CoX_3 mm |
|---|---|---|---|---|---|
| Low Temperature | 0.53 | 0.48 | 0.32 | 0.31 | 0.46 |
| High Temperature | 0.26 | 0.26 | 0.21 | 0.25 | 0.32 |

Interfaces

| | | | | | |
|---|---|---|---|---|---|
| Low Temperature | 0.42 | 0.43 | 0.25 | 0.21 | 0.46 |
| High Temperature | 0.27 | 0.19 | 0.14 | 0.21 | 0.37 |

Results from the distribution of the relaxation time study, as well as the EMFT and COMSOL model, reaffirm that the macro-scale interfaces generated with the coextrusion device possess better transport properties than the individual material systems.

In one experiment, Polyethylene Oxide (MW: 1,000,000 g/mol) was used as received. Lithium Perchlorate was used as the lithium salt. LLZO was prepared in-house using a mechanochemical synthesis reported previously. 25 wt. % LLZO-PEO and 75 wt. % LLZO-PEO systems are considered as the two primary systems. The required amount of PEO and LiClO₄ was initially dissolved in acetonitrile. The EO:Li ratio was maintained at 18. Subsequently, LLZO was added to the mixture which was ball-milled in a low energy ball mill until a uniform, homogenized mixture was obtained. The total solid loading for both coextrusion fluids was maintained constant at 15 wt. %.

Two fluids are fed pneumatically to the coextrusion device. Single material films, and coextruded films with 1 mm, 2 mm and 3 mm stripes were manufactured. The architecture of the film was modified by changing the shim plates within the coextrusion device. Coating speed of 300 mm/min was used. Electrolytes with thicknesses ranging from 40-50 μm were fabricated using this coextrusion platform.

Two coextrusion fluids are fed pneumatically to a regular syringe fitted with a nozzle with I.D. of 0.5 mm Striped films are processed by coating the layers for both materials one after the other. Coating speed of 100 mm/min was used. Electrolytes with thicknesses ranging from 40-50 μm were fabricated using this direct write platform.

The coextrusion fluids used in the coating experiments were rheologically studied using a Rheometer. All fluids were studied using a parallel plate geometry with 1000 μm gap thickness. All fluids were presheared at 10 s⁻¹ for 10 s and allowed to rest for 5 minutes prior to any tests to remove any mechanical history in the samples. Shear sweeps were run from 200 s⁻¹ to 0.01 s⁻¹. Frequency sweeps were run from 0.1 rad/s to 600 rad/s. A constant amplitude of 0.1% was applied during oscillating experiments.

Single films were cast on a copper film for ionic conductivity measurement. After drying, the electrolyte films coated on copper were hot pressed at 100° C. and 400 psi for one hour. The hot pressing does not result in any change in the architecture of the coextruded membranes. Free standing electrolyte films were cast on a PTFE substrate for a transference number measurement. All electrochemical tests were performed on a potentiostat. Ionic conductivity of the electrolytes was measured by carrying out AC impedance measurements between 1 MHz and 1 Hz with an amplitude of 10 mV.

Transference number measurements were carried out by polarization method in a Li|Elyte|Li configuration. Distribution of relaxation time characterization was carried out for Nyquist impedance spectra obtained at room temperature. Galvanostatic charge-discharge studies were carried out on symmetric cells. A constant current of 20 μA is applied for a duration of 10 minutes for 50 cycles. Cells are characterized by AC impedance spectroscopy before and after cycling.

EMFT is used to predict the properties of the interfacial layer using the known values of ceramic, polymer, and the composite electrolyte conductivity. A very thin interfacial layer (t<<R) is assumed to simplify and aid the estimation. This is a fairly reasonable assumption for the hybrid electrolyte systems under study. The overall equation is given as:

$$( 1 - {f}_{c} ) \frac{{σ}_{pol} - {σ}_{comp}}{{σ}_{comp} + {Li}^{*} ( {σ}_{pol} - {σ}_{comp} )} + {f}_{c} \frac{{σ}_{int} - {σ}_{comp}}{{σ}_{comp} + {Li}^{*} ( {σ}_{int} - {σ}_{comp} )} = 0$$

where, σ_{cer}, σₚₒₗ, and σᵢₙₜ are the conductivities of ceramic phase, polymer phase, and the interfacial layer, σ_{comp} is effective conductivity of the hybrid electrolyte, and σ_{eff} is the effective conductivity of the system of the ceramic and the interface. Li* is the effective depolarization factor, and fₑ is the volume fraction of the inserted grains. The conductivity of the interface is obtained by solving this implicit equation. Additionally, this model is used to estimate the conductivities of the interfacial region arising within a co-extruded system.

3D simulations were carried out on a 6 mm×10 mm electrolyte domain with 60 μm thickness. This domain was subdivided into three domains of 2×10 mm each. The outer two domains were assigned physical and electrochemical properties of 25 wt. % system, while the inner domain was assigned the properties of 75 wt. % system. Steady state flux profiles through the electrolyte were evaluated. 1 mA/cm² current density was imposed as a boundary condition.

A number of implementations have been described. Nevertheless, it will be understood that various modifications may be made without departing from the spirit and scope of the claims. Accordingly, other implementations are within the scope of the following claims.

Certain terminology is used herein for convenience only and is not to be taken as a limitation on the present claims. In the drawings, the same reference numbers are employed for designating the same elements throughout the several figures. A number of examples are provided, nevertheless, it will be understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

What is claimed is:

1. A coextrusion device comprising:
a first shim plate having a first side, a second side opposite and spaced apart from the first side of the first shim plate, a first end, and a second end opposite and spaced apart from the first end of the first shim plate, the second end of the first shim plate defining one or more first outlet openings, wherein a first flow channel extends from each of the one or more first outlet openings and extends along a centralized first axis from the second end of the first shim plate toward the first end of the first shim plate; and
a second shim plate coupled to the first shim plate, the second shim plate having a first side, a second side opposite and spaced apart from the first side of the second shim plate, a first end, and a second end opposite and spaced apart from the first end of the second shim plate, the second end of the second shim plate defining one or more second outlet openings, wherein a second flow channel extends from each of the one or more second outlet openings and extends along a centralized second axis from the second end of the second shim plate toward the first end of the second shim plate,
wherein a first central plane extends perpendicular to the first side of the first shim plate and along each of the centralized first axes and a second central plane extends perpendicular to the first side of the second shim plate and along each of the centralized second axes such that the first central planes and second central planes intersect an axis perpendicular to the first central planes and second central planes and are spaced apart from each other.

2. The device of claim 1, wherein each of the first outlet openings has a first edge and a second edge, the first edge and the second edge being opposite and spaced apart from each other, wherein an edge plane extends along each of the first edges and second edges, and none of the edge planes intersects any of the one or more second outlet openings.

3. The device of claim 1, wherein the one or more first flow channels are not in fluid communication with the one or more second flow channels.

4. The device of claim 1, further comprising a flow separator having a first side, a second side opposite and spaced apart from the first side of the flow separator, a first end, and a second end opposite and spaced apart from the first end of the flow separator, wherein the second side of the first shim plate is coupled to the first side of the flow separator and the second side of the flow separator is coupled to the first side of the second shim plate.

5. The device of claim 1, further comprising:
a first flow divider having a first side, a second side opposite and spaced apart from the first side of the first flow divider, a first end, and a second end opposite and spaced apart from the first end of the first flow divider, the first side of the first flow divider defining a first divider opening extending from the first side of the first flow divider to the second side of the first flow divider; and
a second flow divider having a first side, a second side opposite and spaced apart from the first side of the second flow divider, a first end, and a second end opposite and spaced apart from the first end of the second flow divider, the first side of the second flow divider defining a second divider opening extending from the first side of the second flow divider to the second side of the second flow divider,
wherein the second side of the first flow divider is coupled to the first side of the first shim plate such that the first divider opening is in fluid communication with each of the one or more first flow channels, and
wherein the second side of the second shim plate is coupled to the first side of the second flow divider such that the second divider opening is in fluid communication with each of the one or more second flow channels.

6. The device of claim 5, further comprising:
a first inlet plate having a first side, a second side opposite and spaced apart from the first side of the first inlet plate, a first end, and a second end opposite and spaced apart from the first end of the first inlet plate, the first side of the first inlet plate defining a first inlet port extending from the first side of the first inlet plate to the second side of the first inlet plate; and
a second inlet plate having a first side, a second side opposite and spaced apart from the first side of the second inlet plate, a first end, and a second end opposite and spaced apart from the first end of the second inlet plate, the first side of the second inlet plate defining a second inlet port extending from the first side of the second inlet plate to the second side of the second inlet plate,
wherein the second side of the first inlet plate is coupled to the first side of the first flow divider such that the first inlet port is in fluid communication with each of the one or more first flow channels, and
wherein the second side of the second flow divider is coupled to the first side of the second inlet plate such that the second inlet port is in fluid communication with each of the one or more second flow channels.

7. The device of claim 6, wherein each of the first inlet plate, the first flow divider, the first shim plate, the flow divider, the second shim plate, the second flow divider, and the second inlet plate include at least one fastener opening for coupling the first inlet plate, the first flow divider, the first shim plate, the flow divider, the second shim plate, the second flow divider, and the second inlet plate to each other.

8. The device of claim 1, further comprising:
a first pressure regulator in fluid communication with the one or more first flow channels and configured to regulate the pressure of a first fluid to the first flow channels; and
a second pressure regulator in fluid communication with the one or more second flow channels and configured to regulate the pressure of a second fluid to the one or more second flow channels.

9. The device of claim 1, further comprising a computer numerical control (CNC) machine coupled to the first and second shim plates.

10. The device of claim 8, wherein the first fluid and the second fluid each comprise an ion conductor.

11. A method of coextruding a solid electrolyte film, the method comprising:
positioning a coextrusion device above a surface, the device comprising:
a first shim plate having a first side, a second side opposite and spaced apart from the first side of the first shim plate, a first end, and a second end opposite and spaced apart from the first end of the first shim plate, the second end of the first shim plate defining one or more first outlet openings, wherein a first flow channel extends from each of the one or more first outlet openings and extends along a centralized first axis from the second end of the first shim plate toward the first end of the first shim plate; and
a second shim plate coupled to the first shim plate, the second shim plate having a first side, a second side opposite and spaced apart from the first side of the second shim plate, a first end, and a second end opposite and spaced apart from the first end of the second shim plate, the second end of the second shim plate defining one or more second outlet openings, wherein a second flow channel extends from each of the one or more second outlet openings and extends along a centralized second axis from the second end of the second shim plate toward the first end of the second shim plate,
wherein a first central plane extends perpendicular to the first side of the first shim plate and along each of the centralized first axes and a second central plane extends perpendicular to the first side of the second shim plate and along each of the centralized second axes such that the first central planes and second central planes intersect an axis perpendicular to the first central planes and second central planes and are spaced apart from each other;
introducing a first fluid into each of the first flow channels such that the first fluid flows through the first flow channels, out of the one or more first outlet openings, and onto the surface;
introducing a second fluid into each of the second flow channels such that the second fluid flows through the second flow channels, out of the one or more second outlet openings, and onto the surface; and
moving the device in a direction parallel to the surface.

12. The method of claim 11, wherein each of the first outlet openings has a first edge and a second edge, the first edge and the second edge being opposite and spaced apart from each other, wherein an edge plane extends along each of the first edges and second edges, and none of the edge planes intersects any of the one or more second outlet openings.

13. The method of claim 11, wherein the one or more first flow channels are not in fluid communication with the one or more second flow channels.

14. The method of claim 11, wherein the device further comprises a flow separator having a first side, a second side opposite and spaced apart from the first side of the flow separator, a first end, and a second end opposite and spaced apart from the first end of the flow separator, wherein the second side of the first shim plate is coupled to the first side of the flow separator and the second side of the flow separator is coupled to the first side of the second shim plate.

15. The method of claim 11, wherein the device further comprises:
a first flow divider having a first side, a second side opposite and spaced apart from the first side of the first flow divider, a first end, and a second end opposite and spaced apart from the first end of the first flow divider, the first side of the first flow divider defining a first divider opening extending from the first side of the first flow divider to the second side of the first flow divider; and
a second flow divider having a first side, a second side opposite and spaced apart from the first side of the second flow divider, a first end, and a second end opposite and spaced apart from the first end of the second flow divider, the first side of the second flow divider defining a second divider opening extending from the first side of the second flow divider to the second side of the second flow divider,
wherein the second side of the first flow divider is coupled to the first side of the first shim plate such that the first divider opening is in fluid communication with each of the one or more first flow channels, and
wherein the second side of the second shim plate is coupled to the first side of the second flow divider such that the second divider opening is in fluid communication with each of the one or more second flow channels.

16. The method of claim 15, wherein the device further comprises:
a first inlet plate having a first side, a second side opposite and spaced apart from the first side of the first inlet plate, a first end, and a second end opposite and spaced apart from the first end of the first inlet plate, the first side of the first inlet plate defining a first inlet port extending from the first side of the first inlet plate to the second side of the first inlet plate; and
a second inlet plate having a first side, a second side opposite and spaced apart from the first side of the second inlet plate, a first end, and a second end opposite and spaced apart from the first end of the second inlet plate, the first side of the second inlet plate defining a second inlet port extending from the first side of the second inlet plate to the second side of the second inlet plate,
wherein the second side of the first inlet plate is coupled to the first side of the first flow divider such that the first inlet port is in fluid communication with each of the one or more first flow channels, and
wherein the second side of the second flow divider is coupled to the first side of the second inlet plate such that the second inlet port is in fluid communication with each of the one or more second flow channels.

17. The method of claim 16, wherein each of the first inlet plate, the first flow divider, the first shim plate, the flow divider, the second shim plate, the second flow divider, and the second inlet plate include at least one fastener opening for coupling the first inlet plate, the first flow divider, the first shim plate, the flow divider, the second shim plate, the second flow divider, and the second inlet plate to each other.

18. The method of claim 11, wherein the device further comprises:
a first pressure regulator in fluid communication with the one or more first flow channels and configured to regulate the pressure of the first fluid to the first flow channels; and
a second pressure regulator in fluid communication with the one or more second flow channels and configured to regulate the pressure of the second fluid to the one or more second flow channels.

19. The method of claim 11, wherein the device further comprises a computer numerical control (CNC) machine coupled to the first and second shim plates.

20. The device of claim 11, wherein the first fluid and the second fluid each comprise an ion conductor.
